(19) United States
(12) Patent Application Publication
(10) Pub. No.: US 2006/0098693 A1
(43) Pub. Date: May 11, 2006

(54) Busbar arrangement for coupling waveguide filters in output multiplexers

(75) Inventors: Franz-Josef Goertz, Burgstetten (DE); Dieter Wolk, Bachnang (DE); Dieter Schmitt, Wallenaav (NL); Juergen Damaschke, Heilbronn (DE)

Correspondence Address: JORDAN AND HAMBURG LLP, 122 EAST 42ND STREET, SUITE 4000, NEW YORK, NY, 10168, US

(73) Assignee: TESAT SPACECOM GMBH & CO. KG, Backnang (DE)

(21) Appl. No.: 10/538,586

(22) PCT Filed: Feb. 19, 2004
(86) PCT No.: PCT/DE04/00307

§ 371 Date: Nov. 14, 2005

(30) Foreign Application Priority Data
Feb. 19, 2003 (DE) 103 07 111.3

(51) Int. Cl. H04J 3/04

(52) U.S. Cl. 370/534; 398/177; 385/37

(57) ABSTRACT

A busbar arrangement for coupling waveguide filters of output multiplexers wherein the side walls of short-circuited T-shaped or Y-shaped branch regions of the busbar are constructed for coupling the waveguide filters.

The invention starts out from a busbar arrangement for coupling waveguide filters of output multiplexers of the type described in the main claim.

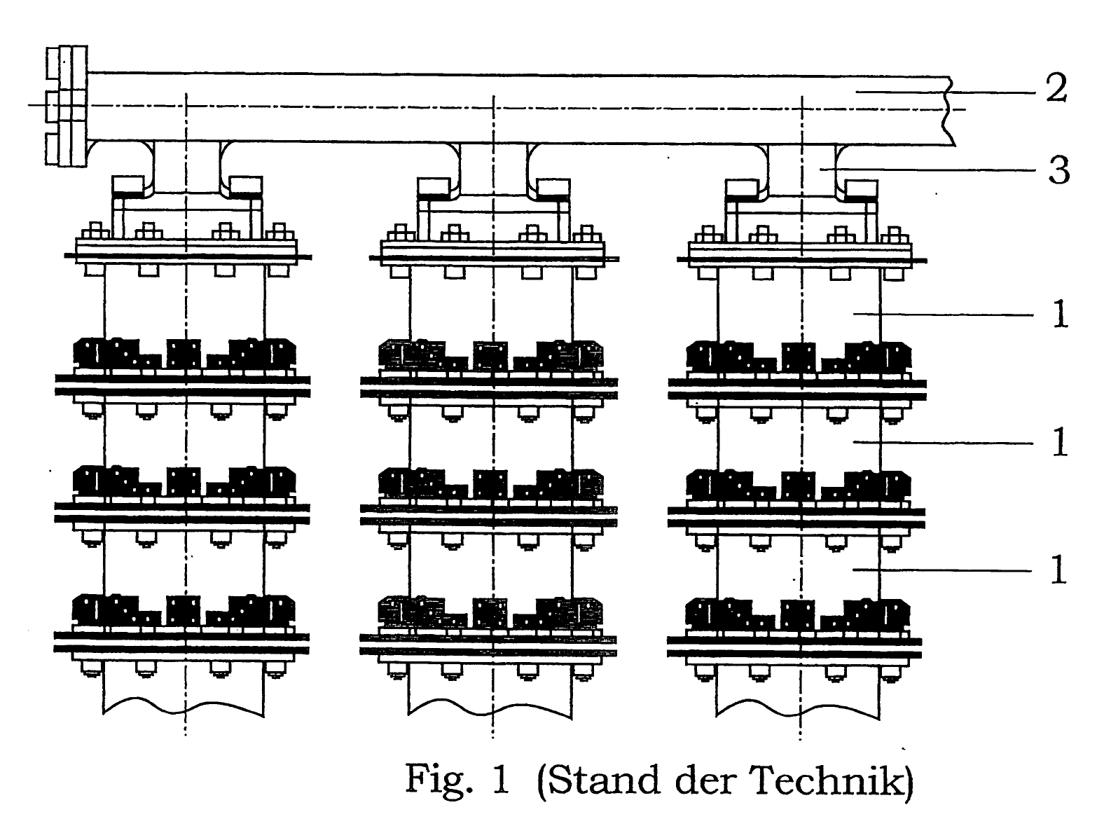

Output multiplexers for use in communication satellites have channel filters and a coupling device in the form of a busbar, also referred to as a manifold. The channel filters are constructed as coupled waveguide filters, whereas the busbar consists of a short-circuited waveguide of rectangular cross section with a plurality of T-shaped branches. Such a typical arrangement is known from DE 38 14 748 C1 and shown here in FIG. 1. The branches may be coupled to the narrow sides of the busbar profile and are then referred to as H branching, whereas coupling to the broad side is referred to as an E branching.

The waveguide filters themselves are coupled at end faces over diaphragms as a so-called in-line arrangement. Short pieces of waveguides, the length of which is determined by the respective channel center frequency of the channel filter, in each case connect the T branches of the bus bar with the individual input diaphragms of the waveguide filters functioning as channel filters. Generally, flange connections are used here.

On the one hand, waveguide filters may all be disposed on one side of the busbar and therefore form a so-called combline arrangement. On the other hand, the possibility also exists of mounting the channel filters on both sides of the busbar in a herringbone arrangement, as, for example, in EP 293 419 B1. In so doing, however, certain spacing rules must be observed, which result in an undesirable length for the busbar arrangement.

More compact and, with that, lighter multiplexers can be achieved if the waveguide filters are disposed perpendicularly and are coupled over their side walls. In this case, inputs and outputs are on the end faces of the filters and the busbar is passed over the filters (U.S. Pat. No. 5,235,297). However, with the previously customary busbars, only a one-sided coupling of the channel filters to the busbar is possible.

In comparison to solutions of the state of the art, the inventive busbar arrangement for coupling waveguide filters of output multiplexers with the characterizing distinguishing features of the main claim has the advantages that a significantly more compact overall arrangement is achieved because it is possible to couple the waveguide filters on both sides to the side walls of the busbar. At the same time, the advantage of a greatly reduced weight is associated with this. Both advantages are of particular importance in the field of communication satellites, where the best utilization of the limited transporting space and, at the same time, the least weight of the equipment carried by the satellite matter a great deal. Moreover, the novel busbar arrangement for coupling waveguide filters is distinguished because of the greatly simplified coupling structures due to the particularly convenient installation and, with that, because of the decreased manufacturing costs.

According to an advantageous development of the invention, the end face of a T-shaped branch of the busbar no longer is constructed as a coupling element, to which the waveguide filter may be coupled. Pursuant to the invention, the end faces of the T-shaped busbar branches are constructed as short-circuited in the form of a closed wall. In this connection, signals are coupled into the waveguide filters in two different ways.

If the branching of the busbar over the narrow sides of the busbar profile is present as an H branching, the resonators are coupled over the short-circuited waveguide region forming a coupling diaphragm in the broad side of the T-branching of the busbar arrangement. Moreover, the coupling diaphragm is disposed in the area of the magnetic field strength maximum of said waveguide region.

If the branching of the busbar over the broad sides of the busbar profile is present as E branching, the resonators are coupled over a short-circuited waveguide region forming a coupling diaphragm in the narrow side of the T branch of the busbar arrangement. Moreover, the coupling diaphragm once again is disposed in the area of the electrical field strength maximum of said waveguide region.

In both cases of the configuration of the busbar branches, the busbar, with its branches, passes over the upright side wall-coupled channel filters or waveguide filters.

It is an advantage of such an arrangement that it is clearly possible to shorten the busbar arrangement by being able to couple the channel filters or waveguide filters to both sides. The possibility of coupling the filters to the side walls instead of to the end faces of the busbar is a further possibility for making the space, required by the arrangement as a whole, smaller. The above comments apply correspondingly to Y branches.

In a particular embodiment of the invention, the busbar, passed over the upright, side wall-coupled channel filters or waveguide filters is temperature compensated. By these means, especially when the output multiplexer is used within satellite communication, the extreme temperature fluctuations existing there are taken into account and the effect of these fluctuations on the transmission behavior and the frequency selectivity of the busbar arrangement is decreased.

Further advantages and advantageous configurations of the invention are given in the following description, the drawing and the claims.

Examples of the invention are described in greater detail in the following and shown in the drawings, in which

FIG. 1 shows a typical busbar arrangement of the state of the art,

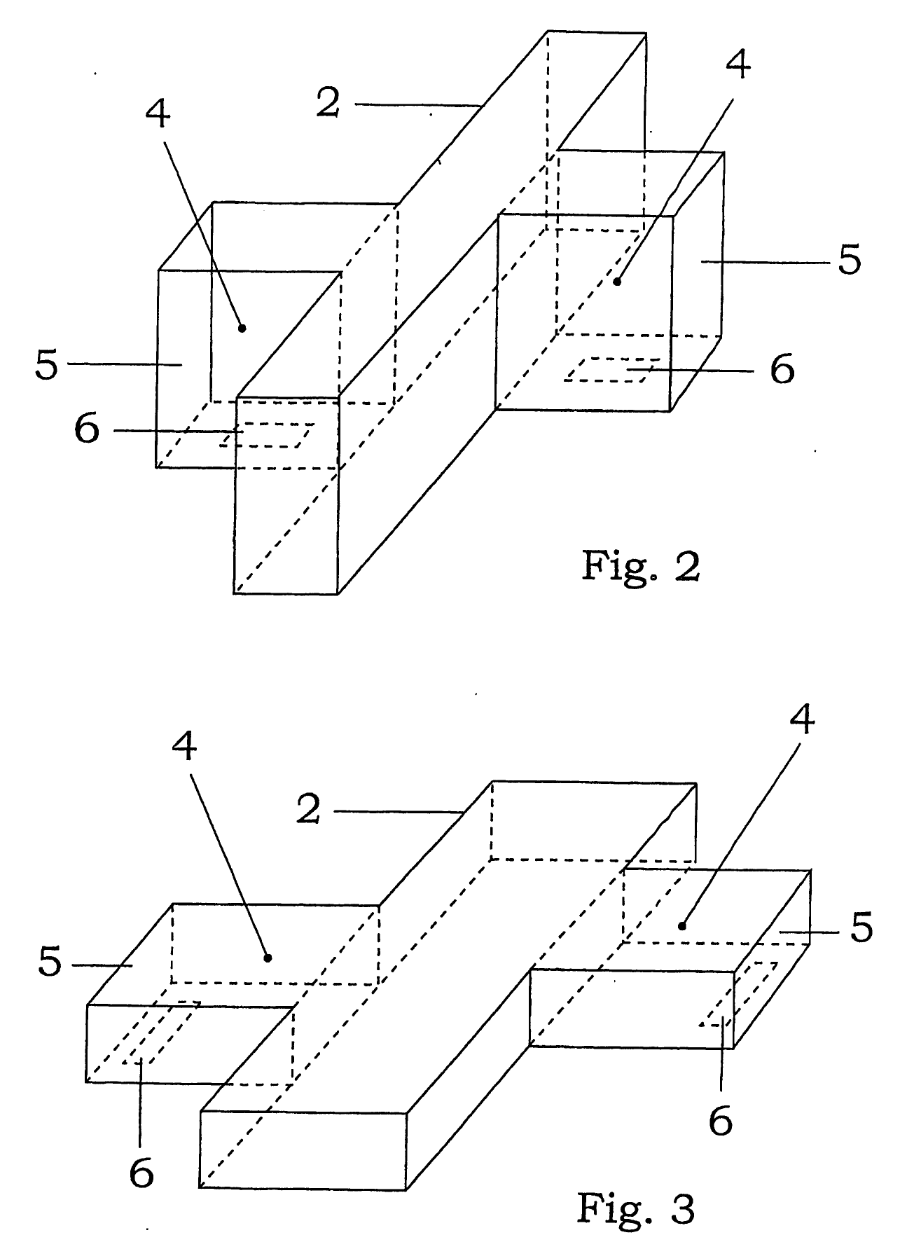

FIG. 2 shows an inventive busbar arrangement with a short-circuited branch region as an E branch,

FIG. 3 shows an inventive busbar arrangement with a short-circuited branch region as an H branch and

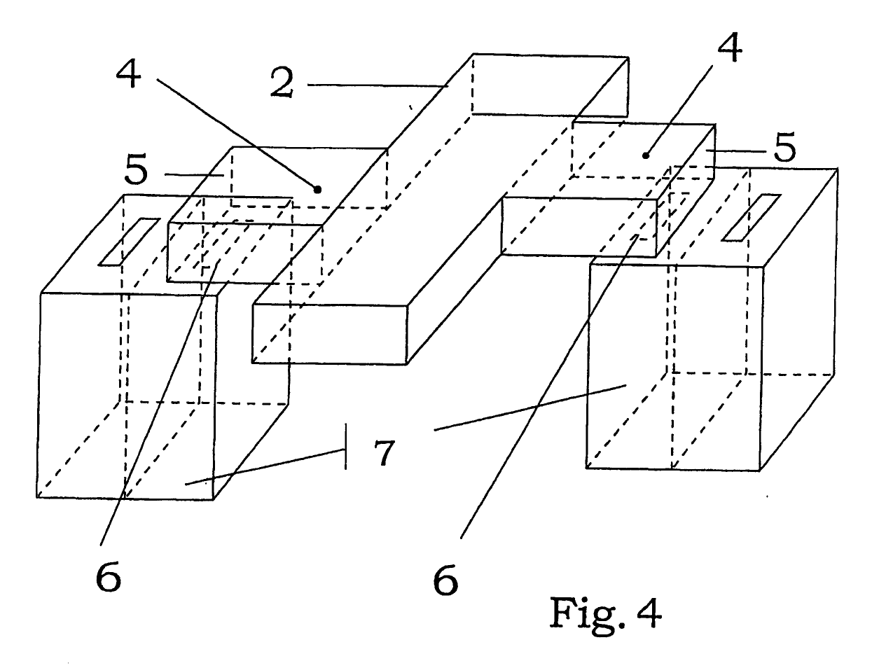

FIG. 4 shows an inventive busbar arrangement with a short-circuited branch region as an H branch and waveguide filters coupled to both sides.

An inventive busbar arrangement, comprising a busbar 2 with a short circuited branch region 4 as E branch is shown in FIG. 2. With respect to the branches, the rectangular cross-sectional profile of the busbar 2 is placed so that the busbar 2 rests on its narrow side and the branch regions 4 in each case are at the broad sides of the busbar 2. The end faces 5 of the branching regions 4, constructed as a wall, form a waveguide-like short circuit. The openings in the sidewall of the branching regions 4, shown in each case at the bottom, serve as coupling diaphragms 6 for coupling channel filters 1 and waveguide filters 7 with the busbar 2 of the multiplexer.

An also inventive busbar arrangement of a busbar 2 with a short-circuited branch region 4 as H branching is shown in FIG. 3. With respect to the branches, the rectangular cross-sectional profile of the busbar 2 is placed so that the busbar 2 lies on its broad side and the branching regions 4 in each case are at the narrow sides of the busbar 2. The end faces 5 of the branching regions 4, constructed as a wall, once again form a waveguide-like short-circuited. The openings in the sidewall of the branch regions 4, shown in each case at the bottom, serve as coupling diaphragms 6 for coupling channel filters 1 and waveguide filters 7 with the busbar 2 of the multiplexer arrangement.

An inventive busbar arrangement with a short-circuited branch region 4 as H branching and coupled waveguide filters 7 is shown in FIG. 4. The coupling of the waveguide filters 7 is constructed as a side wall coupling over coupling diaphragms 6, the waveguide filters 7 being upright and the busbar 2, with its short-circuited branch regions 4 being above the coupled waveguide filters 7.

All the distinguishing features, shown in the specification, the subsequent claims and the drawing, may be essential to the invention individually as well as in any combination with one another.

### LIST OF REFERENCE SYMBOLS

1 channel filter
2 busbar
3 T-shaped or Y-shaped branch
4 branch region
5 front face
6 coupling diaphragm
7 waveguide filter

1. Busbar arrangement for coupling waveguide filters of output multiplexers, comprising a busbar with T-shaped or Y-shaped branch regions, the side walls of short-circuited T-shaped or Y-shaped branch regions of the busbar being constructed for coupling waveguide filters.

2. The busbar arrangement of claim 1, wherein, in the case of a herringbone arrangement of the output multiplexer, the busbar with its short-circuited branch regions is passed over upright side wall-coupled waveguide filters.

3. The busbar arrangement of claim 1, wherein coupling diaphragms are present in the side walls of the branch regions for uncoupling from the busbar.

4. The busbar arrangement of claim 2, wherein the busbar is constructed temperature-compensated.
